(19) United States
(12) Patent Application Publication
(10) Pub. No.: US 2022/0075904 A1
(43) Pub. Date: Mar. 10, 2022

(54) INFORMATION PROCESSING APPARATUS AND CONTROL METHOD THEREOF

(71) Applicant: CANON KABUSHIKI KAISHA, Tokyo (JP)

(72) Inventors: Yohei Horikawa, Tokyo (JP); Takeshi Ogawa, Tokyo (JP)

(21) Appl. No.: 17/411,457

(22) Filed: Aug. 25, 2021

(30) Foreign Application Priority Data
Sep. 4, 2020 (JP) 2020-149178

(51) Int. Cl. G06F 21/79; G06F 21/72; H04L 9/08

(52) U.S. Cl. CPC G06F 21/79; H04L 9/0869; G06F 21/72

(57) ABSTRACT

As one of possible embodiments, an information processing apparatus capable of protecting data stored in a non-volatile storage device more reliably is disclosed. The apparatus comprises an encryption circuit that encrypts data; a writing circuit that stores the data encrypted by the encryption circuit in a non-volatile storage device; and a volatile storage device that stores information used to decrypt the data encrypted by the encryption circuit.

### BACKGROUND OF THE INVENTION

### Field of the Invention

The present invention relates to an information processing apparatus and a control method thereof, and in particular to data management technique.

### Description of the Related Art

Conventionally, in a computing device, a volatile storage device such as DRAM and a non-volatile storage device such as EEPROM are used in different ways depending on an application of stored data. For example, information required at the time of starting up the device and information to be used repeatedly, such as device settings, are stored in a non-volatile storage device. On the other hand, information that is used temporarily, such as a program being executed and its variables, and data being processed, is stored in a volatile storage device.

The information stored in the non-volatile storage device continues to be stored unless it is explicitly deleted. Therefore, a method for protecting confidential information stored in a non-volatile storage device has been proposed. Japanese Patent Laid-Open No. 2015-90682 discloses that, in an image forming apparatus that uses a non-volatile storage device as a main memory, deleting the data stored in the non-volatile storage device when a shutdown instruction is detected.

However, the method proposed in Japanese Patent Laid-Open No. 2015-90682 may allow a third party to read out the data stored in the non-volatile storage device if the shutdown instruction cannot be detected, for example, in a case where the power supply to the image forming apparatus is forcibly cut off.

### SUMMARY OF THE INVENTION

The present invention was made in consideration of such a problem of the conventional technology. The present invention provides in its an aspect an information processing apparatus and a control method thereof capable of protecting data stored in a non-volatile storage device more reliably.

According to an aspect of the present invention, there is provided an information processing apparatus comprising: an encryption circuit that encrypts data; a writing circuit that stores the data encrypted by the encryption circuit in a non-volatile storage device; and a volatile storage device that stores information used to decrypt the data encrypted by the encryption circuit.

According to another aspect of the present invention, there is provided a control method of an information processing apparatus, comprising: encrypting data; writing the encrypted data to a non-volatile storage device; and writing information used for decrypting the encrypted data to a volatile storage device.

According to a further aspect of the present invention, there is provided a non-transitory machine-readable medium storing a program for causing a computer to execute a control method of an information processing apparatus, the control method comprising: encrypting data; writing the encrypted data to a non-volatile storage device; and writing information used for decrypting the encrypted data to a volatile storage device.

Further features of the present invention will become apparent from the following description of exemplary embodiments (with reference to the attached drawings).

### BRIEF DESCRIPTION OF THE DRAWINGS

FIG. 1 is a block diagram showing an example of a functional configuration of a digital camera 100 according to an embodiment.

FIG. 2 is a diagram showing an example of a memory map of a non-volatile storage device 112.

FIG. 3 is a diagram showing an example of a functional configuration of a key generation circuit 110.

FIG. 4 is a diagram showing an example of a functional configuration of an encryption processing circuit 108.

FIG. 5 is a timing chart regarding encryption operations according to an embodiment.

FIG. 6 is a timing chart regarding encryption operations according to an embodiment.

FIG. 7 is a diagram showing another example of a memory map of the non-volatile storage device 112 according to a variation of an embodiment.

FIG. 8 is a diagram showing another example of the key generation circuit 110 according to a variation of an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. In the attached drawings, the same reference numerals denote the same or similar parts and a repetitive description thereof will be omitted.

In the following, the present invention is described with respect to an embodiment in which the present invention is applied to a digital camera as an example of an information processing apparatus. However, an image capturing function is not essential to the present invention and thus the present invention can be implemented in common electronic devices. Such electronic devices include video cameras, computing devices (personal computers, tablet computers, media players, PDAs, etc.), mobile phones, smart phones, game consoles, robots, drones, and drive recorders. These are non-exhaustive examples, and the present invention can be implemented in other electronic devices.

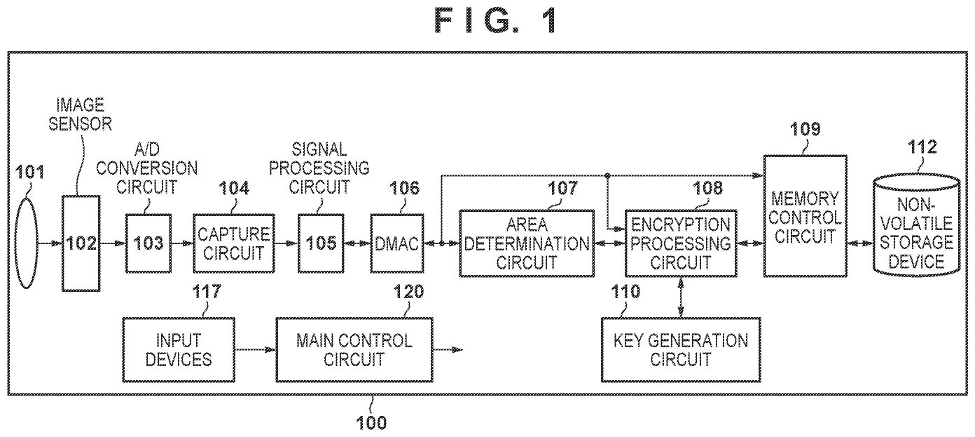

FIG. 1 is a block diagram showing an exemplary structure of a digital camera 100 according to an embodiment of the present invention. The digital camera 100 uses a non-volatile storage device 112 as a primary storage device (a main memory). Accordingly, the non-volatile storage device 112 provides not only a function as a ROM for storing a program, various settings, GUI data, etc., but also a function as a RAM for storing temporary data such as intermediate data, a program being executed and its variables. Accordingly, even when the power of the digital camera 100 is turned off, the temporary data is not immediately deleted, but continues to be stored in the non-volatile storage device 112. The non-volatile storage device 112 can be realized by a non-volatile semiconductor memory device such as an SSD (Solid State Drive) and an MRAM (Magnetoresistive Random Access Memory) device, for example, but another device can be used as long as it can be used as the main memory. The details of the non-volatile memory device 112 will be described later.

An imaging optical system 101 includes an optical lens group including a movable lens such as a focusing lens, a shutter, and an aperture, etc. The imaging optical system 101 forms an optical image on an imaging plane of an image sensor 102. The operation of the movable lenses, shutter, and aperture of the imaging optical system 101 is controlled by the main control circuit 120. The shutter and aperture may not be included in the imaging optical system 101.

The image sensor 102 is, for example, a CMOS image sensor with a color filter array (CFA) in which primary colors are arranged according to Bayer pattern. The image sensor 102 has a plurality of pixels arranged in a two-dimensional array. A photoelectric conversion device (a photodiode) is formed in each pixel and generates electric charges corresponding to an amount of incident light during an exposure period. Since millions to tens of millions of pixels are formed in the image sensor 102, there may be pixels that do not operate properly (sometimes referred to as “defective pixels”). An output of a defective pixel cannot be used as it is. Therefore, the output is corrected by a defective pixel correction process that is performed by a signal processing circuit 105 and is described below.

The signal read out from each pixel of the image sensor 102 (an analog image signal) is converted into a digital image signal (image data) by an A/D conversion circuit 103. The A/D conversion circuit 103 may apply noise reduction processing, amplification processing, etc., to the analog image signal before A/D conversion. The image data output by the A/D conversion circuit 103 is supplied to the signal processing circuit 105.

The signal processing circuit 105 applies predetermined image processing to the image data input from the A/D conversion circuit 103 in order to generate signals and image data, and to acquire and/or generate various types of information. The signal processing circuit 105 may, for example, be a dedicated hardware circuit such as an ASIC designed to realize a specific function, or may have a configuration in which a programmable processor such as a DSP executes software to realize the specific function.

The image processing applied by the signal processing circuit 105 includes pre-processing, color interpolation processing, correction processing, detection processing, data processing, evaluation value calculation processing, and special effect processing. The pre-processing includes the defective pixel correction process described above.

The color interpolation processing is a process to interpolate values of color components that are not obtained at the time of capturing, and is also referred to as demosaicing processing or synchronization processing. The correction processing includes white balance adjustment, tone correction (gamma processing), correction of effects of optical aberration and/or vignetting of the imaging optical system 101, and color correction, etc.

The detection processing includes detection processing to detect of feature areas (e.g., face area and/or human body area) and their movements, and person recognition processing. The data processing includes composition processing, scaling processing, encode and decode processing, and header information generation processing.

The evaluation value calculation processing includes processing for generating signals and evaluation values used for automatic focus detection (AF) and processing for calculating evaluation values used for automatic exposure control (AE), etc. The special effect processing includes processing for adding blur, changing color tone, and re-lighting, etc. The above-identified processing is exemplary image processing that can be applied by the signal processing circuit 105, and do not limit image processing that the signal processing circuit 105 can apply.

The signal processing circuit 105 can perform image processing on image data for one frame such that by performing the image processing for each partial area (predetermined processing unit) obtained by dividing the image data. This allows an amount of a buffer memory in the signal processing circuit 105 and/or the capability of the signal processing circuit 105 to be reduced and thereby reducing power consumption.

In a case where performing the image processing on each predetermined processing unit of the image data, the signal processing circuit 105 once stores the image data supplied from the A/D conversion circuit 103 in the non-volatile storage device 112. Thereafter, the signal processing circuit 105 reads out the image data for the processing unit from the non-volatile storage device 112 to apply the image processing, and then stores the processed data in the non-volatile storage device 112 again. During applying the image processing to one processing unit of the image data, intermediate data of the image processing could be stored into and read from the non-volatile storage device 112 one or more times. By repeatedly applying the image processing to the image data for respective processing units, the signal processing circuit 105 applies the image processing to the image data for one frame.

The signal processing circuit 105 accesses the non-volatile storage device 112 via a DMAC 106 and a memory control circuit 109. The signal processing circuit 105 can, for example, apply the image processing to each processing unit obtained by dividing in the horizontal direction image data for one pixel line.

The signal processing circuit 105 may apply the image processing without dividing the image data for one frame. In this case also, the intermediate data of the image processing could be stored in and read out from the non-volatile storage device 112 one or more times during applying the image processing.

The signal processing circuit 105 generates image data for recording and/or image data for display by applying the image processing. These image data can be recorded into a memory card or the like, output to an external device, or displayed on a display device of the digital camera 100. In addition, the evaluation values generated by the signal processing circuit 105 are supplied to the main control circuit 120 and used for AF and AE processing in the main control circuit 120.

When storing the generated data into the non-volatile storage device 112, the signal processing circuit 105 determines whether encryption of the generated data is required or not according to the type of the data. In addition, the signal processing circuit 105 knows address spaces of a secret area and a normal area (described below) that are set to the non-volatile storage device 112. If the signal processing circuit 105 has generated data to be stored in the non-volatile storage device 112, the signal processing circuit 105 sets to the DMAC 106 information required for DMA transfer, such as a source address of the buffer memory in the signal processing circuit 105 and a destination address in the non-volatile storage device 112. When the data to be transferred (stored) has been prepared in the buffer memory, the signal processing circuit 105 outputs a DMA request to the DMAC 106.

When the signal processing circuit 105 reads out data from the non-volatile storage device 112, the signal processing circuit 105 also sets to the DMAC 106 the information required for DMA transfer and then outputs a DMA request to the DMAC 106. In this case, the source address of the transfer is an address of the non-volatile storage device 112 and the destination address is an address of the buffer memory in the signal processing circuit 105.

The DMAC 106 transfers data from the signal processing circuit 105 to the non-volatile storage device 112 in accordance with the settings made by the signal processing circuit 105. The DMAC 106 outputs control signals for the data transfer to an area determination circuit 107, an encryption processing circuit 108, and the memory control circuit 109.

Specifically, the DMAC 106 outputs a REQ signal, an ADR signal, a WRITE_EN signal, and a D signal as control signals for reading and writing (storing) data from/to the non-volatile storage device 112. The REQ signal is a request signal for reading or writing data from/to the non-volatile storage device 112. The ADR signal is a signal indicating the addresses for which read/write is requested. The WRITE_EN signal is a signal indicating whether a read or write is requested. The D signal is a signal indicating the data to be written.

Upon receiving the REQ signal, the memory control circuit 109 outputs the ACK signal to the DMAC 106. The memory control circuit 109 also outputs the Q signal indicating the data read out from the non-volatile storage device 112 to the encryption processing circuit 108 and the DMAC 106.

The area determination circuit 107 determines whether or not the area for which access is requested by a read/write request is a predetermined secret area, based on the REQ signal and the ADR signal that are output signals of the DMAC 106. The area determination circuit 107 can make the determination based on the information on the address of the secret area being set to the nonvolatile storage device 112 and the address indicated by the ADR signal. The information on the address of the secret area can be stored, for example, in the area determination circuit 107. The area determination circuit 107 outputs an area determination signal of high-level to the encryption processing circuit 108 if it is determined that the area to which the DMAC 106 requests access is the secret area, and an area determination signal of low-level to the encryption processing circuit 108 if it is determined that the area is not the secret area.

The area determination circuit 107 may determine whether or not the destination of the data is the secret area based on the destination address set by the signal processing circuit 105 to the DMAC 106, instead of based on the output signal of the DMAC 106. Alternatively, the area determination circuit 107 may receive a notification from the signal processing circuit 105 as to whether or not the data to be stored is data that should be stored in the secret area.

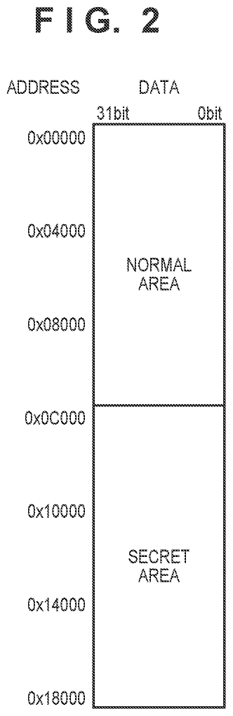

FIG. 2 shows an example of an area setting in the non-volatile storage device 112. The vertical axis represents addresses in bytes of the non-volatile storage device 112, and the horizontal axis represents a 32-bit data space. As an example, it is assumed that the capacity of the non-volatile storage device 112 is 96 KB, the address space from 0x000 to 0xBFFF is set as the normal area and the address space from 0xC000 to 0x17FFF is set as the secret area.

Since encryption is not required for the data to be stored into the normal area, the normal area can be referred to as a non-encrypted area. On the other hand, since encryption is required for data to be stored in the secret area, the secret area can be referred to as an encrypted area. At least one secret area is to be set to the non-volatile storage device 112 whereas the normal area is not essential. The entire area of the non-volatile storage device 112 may be set as the secret area. The setting of the secret area for the non-volatile storage device 112 is determined by the manufacturer of the digital camera 100. In addition, information that can identify the secret area in the nonvolatile storage device 112 is stored, for example, in a memory of the signal processing circuit 105 and/or the area determination circuit 107. The information that can identify the secret area can take various forms such as, for example, a combination of the start address and the end address, a combination of the start address and the size, and information indicating a predetermined setting pattern between the secret area and the normal area.

In addition, it is assumed that it is predetermined which data (information) is to be stored in the secret area. For example, information that the manufacturer of the digital camera 100 wants to keep secret is an example of data to be stored in the secret area (secret information). For example, intermediate data generated by the signal processing circuit 105 during an application of the image processing to the image data is data that should be stored in the secret area because the intermediate data reflect a proprietary technique of the manufacturer.

The main control circuit 120 is a microcontroller having a CPU (processor), ROM, and RAM. The main control circuit 120 controls circuits and/or units of the digital camera 100 by reading a program stored in the ROM into the RAM and executing it by the CPU and thereby realizing the functions of the digital camera 100. Although not shown in FIG. 1, the main control circuit 120 is connected to each of the other blocks in a communicable manner. ROM is, for example, a rewritable non-volatile memory and stores programs executable by the CPU of the main control circuit 120, setting values, GUI data, etc. RAM is used to load a program to be executed by the CPU of the main control circuit 120 and to store necessary values during execution of the program.

The main control circuit 120 may read and execute a program stored in the non-volatile storage device 112. The main control circuit 120 may also store (move) a program stored in the non-volatile storage device 112 in another area of the non-volatile storage device 112 and then execute the program.

The main control circuit 120 performs AF processing and AE processing using the evaluation values obtained from the signal processing circuit 105. In AF processing, the main control circuit 120 adjusts the position of the focusing lens of the imaging optical system 101 so that a focus detection area to be in focus. In AE processing, the main control circuit 120 determines exposure conditions for the image sensor 102 (an aperture value, an exposure time, and a shooting sensitivity), and then adjusts the aperture of the imaging optical system 101 and the settings of the image sensor 102 accordingly.

Input devices 117 is a generic term for buttons, switches, dials, and the like that are provided for the user to input various instructions to the digital camera 100. Each of the input devices 117 has names corresponding to the functions assigned to it. For example, the input device 117 includes a release switch, a moving image recording switch, a shooting mode selection dial for selecting a shooting mode, a menu button, a directional key, a set key, and the like. The release switch is a switch for recording a still image, and the main control circuit 120 recognizes a half-pressed state of the release switch as a shooting preparation instruction and a fully-pressed state of the release switch as a shooting start instruction. In addition, the main control circuit 120 recognizes a press of the moving image recording switch during a shooting standby state as a moving image recording start instruction, a press of the moving image recording switch during moving image shooting as a recording stop instruction. The functions assigned to the same input device may be variable. The input device may be a software button or key using a touch-sensitive display. The input devices 117 may also include an input device that supports non-contact input methods such as voice input and eye input.

A key generation circuit 110 generates an encryption key to be used in the encryption processing circuit 108 in response to an instruction from the main control circuit 120. In this embodiment, it is assumed that the encrypted data can be decrypted using the encryption key used for their encryption. In a case where decryption of the encrypted data uses information different from the encryption key used for the encryption (called the decryption key), the key generation circuit 110 generates the decryption key together with the encryption key.

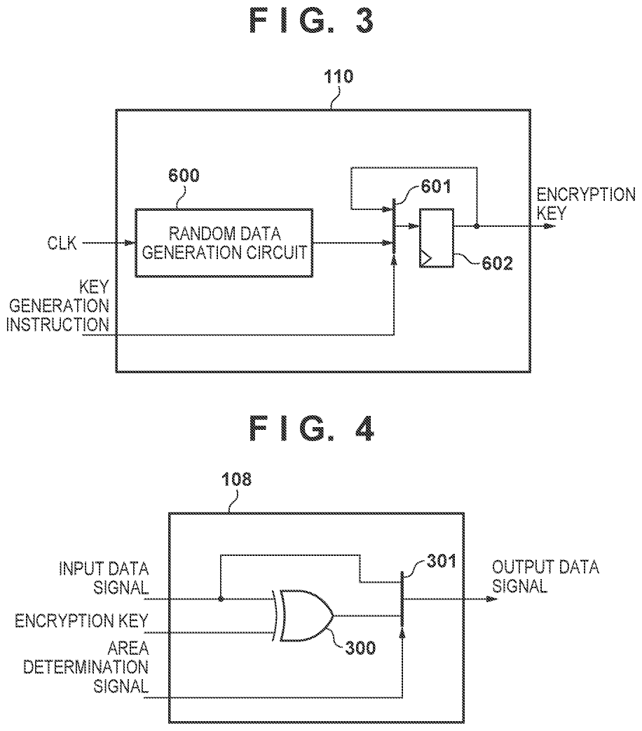

FIG. 3 is a circuit diagram showing an exemplary structure of the key generation circuit 110. The key generation circuit 110 comprises a random data generation circuit 600, a flip-flop 602, and a selector 601. The random data generation circuit 600 is a circuit generating random data. The random data generation circuit 600 generates new data every time a clock signal CLK is input. The clock signal CLK can be obtained, for example, from a signal generated by a clock generation circuit of the digital camera 100. The random data is multi-bit data (e.g., 8-bit data, 24-bit data, 32-bit data, etc.) and is used as the encryption key. Instead of the random data itself, another data obtained based on the random data may be generated as the encryption key.

Here, random data is a value that has no regularity and is unpredictable or difficult to predict. The value should change at least every time it is generated and should not be a value that can be easily generated by a third party from unique data or other data held in the digital camera 100. There is no restriction on the method of generating the random data, but for example, the remainder when the current time is divided by a specific value can be generated as the random data.

The flip-flop 602 is an example of a volatile storage device that holds the encryption key. The flip-flop 602 holds its value as long as power is supplied and holds an input signal at a rising edge of the clock signal CLK. When the power of the digital camera 100 is turned off, the flip-flop 602 can no longer hold data, and thus the encryption key is deleted. Although a single flip-flop 602 is shown in FIG. 3, flip-flops of which the number is equal to the number of bits of random data are arranged in parallel to hold the encryption key as a whole, such that each flip-flop holds one bit of the random data. Another volatile storage device, such as SRAM, may be used instead of the flip-flop 602.

The selector 601 selects the output of the random data generation circuit 600 when the key generation instruction is at a High level. The selector 601 selects the output of the flip-flop 602 when the key generation instruction is at Low level. Therefore, the same random data (encryption key) is held in the flip-flop 602 while the key generation instruction is at Low level. When the key generation instruction becomes High level, the random data output by the random data generation circuit 600 at that time is held in the flip-flop 602 at the rising edge of the clock signal CLK. In other words, when the key generation instruction becomes High level, the encryption key is updated.

The key generation instruction is supplied by the main control circuit 120 to the key generation circuit 110 at a predetermined timing. For example, the main control circuit 120 sets the key generation instruction to a High level when the key generation circuit 110 does not hold the encryption key, such as when the digital camera 100 starts up, thereby causing the volatile storage device of the key generation circuit 110 to hold the encryption key. For example, the main control circuit 120 may set the key generation instruction to a High level before shooting for the live view display is started, such as when the power of the digital camera 100 is turned on from off or when the sleep mode of the digital camera 100 is released.

The main control circuit 120 may also periodically update the encryption key. However, in this case, the data encrypted using the encryption key before the update and stored in the non-volatile storage device 112 cannot be decrypted. For this reason, the encryption key may be updated only when there is no data stored in the secret area of the non-volatile storage device 112 or when the data stored in the secret area is determined to be unnecessary. For example, the main control circuit 120 may determine that intermediate data related to a frame to which image processing has already been applied or data that has been stored for a predetermined period of time or longer are unnecessary.

For example, if the power supply is forcibly stopped, such as when the battery of the digital camera 100 is removed, the encryption key held in the key generation circuit 110 will disappear. On the other hand, the data stored in the secret area of the non-volatile storage device 112 have been encrypted using the encryption key held by the key generation circuit 110. Therefore, even if the non-volatile storage device 112 is removed from the digital camera 100 and analyzed, the data stored in the secret area cannot be decrypted.

The encryption key held in the volatile storage device (i.e., the flip-flop 602) of the key generation circuit 110 can be protected so that it cannot be referenced or read by anyone other than the encryption processing circuit 108 (i.e., by anyone other than encryption means). This can further enhance the confidentiality of the data stored in the secret area of the non-volatile storage device 112.

Returning to FIG. 1, the encryption processing circuit 108 applies the encryption process using the encryption key generated by the key generation circuit 110 to the D signal output by the DMAC 106 that is determined by the area determination circuit 107 as data should be stored in the secret area. The encryption processing circuit 108 outputs the encrypted data to the memory control circuit 109.

The encryption processing circuit 108 applies the decryption process using the encryption key generated by the key generation circuit 110 to the Q signal output by the memory control circuit 109, which is read out from the secret area. The encryption processing circuit 108 outputs the decrypted data to the memory control circuit 109 or the DMAC 106.

FIG. 4 is a circuit diagram showing an exemplary configuration of the encryption processing circuit 108. The encryption processing circuit 108 comprises a logical exclusive OR (XOR) gate as an application circuit 300, and a selector 301. The encryption processing circuit 108 performs encryption when the input data signal is a D signal (write data), and decryption when the input data is a Q signal (read data).

In the example shown in FIG. 4, by implementing the application circuit 300 by an XOR gate to which the encryption key and input data are inputted, encryption and decryption can be realized in the same configuration, and the processing load in encryption and decryption can be suppressed. In other words, the example shown in FIG. 4 is a configuration in which the encryption key is also used as the decryption key. Note that the encryption processing circuit 108 using the XOR gate is just one example, and any encryption and decryption method using the encryption key can be applied.

The encryption of write data (D signal) is described below. Here, it is assumed that each input of the XOR gate is an 8-bit input and that the encryption key is also 8 bits. The input data signal is supplied to one of the inputs of the XOR gate 300 in 8-bit units. The 8-bit encryption key is also supplied from the key generation circuit 110 to the other input of the XOR gate 300. As a result, the logical exclusive OR of the 8-bit input data signal and the encryption key is obtained as the encrypted data. Thereafter, the same encryption is applied to the input data signal every 8 bits.

The decryption of the read data (Q signal) is described below. Again, it is assumed that each input of the XOR gate is an 8-bit input and the encryption key is also 8 bits. If the encryption key used to encrypt the read data and the encryption key supplied from the key generation circuit 110 are the same, the XOR operation between the read data and the encryption key corresponds to the decryption process.

The image processing in the signal processing circuit 105 may be performed in pixel units or block units. Therefore, the encryption processing circuit 108 may be configured to be capable of performing the encryption for each processing unit in image processing. For example, the encryption processing circuit 108 may be configured to allow selection between encryption in pixel units and encryption in macroblock units.

The selector 301 outputs the output of the XOR gate 300 when the area determination signal is at a High level, and outputs the input data signal when the area determination signal is at a Low level. Therefore, the whole area of the non-volatile storage device 112 as the main memory can be divided into a secret area and a normal area according to the address of the non-volatile storage device 112.

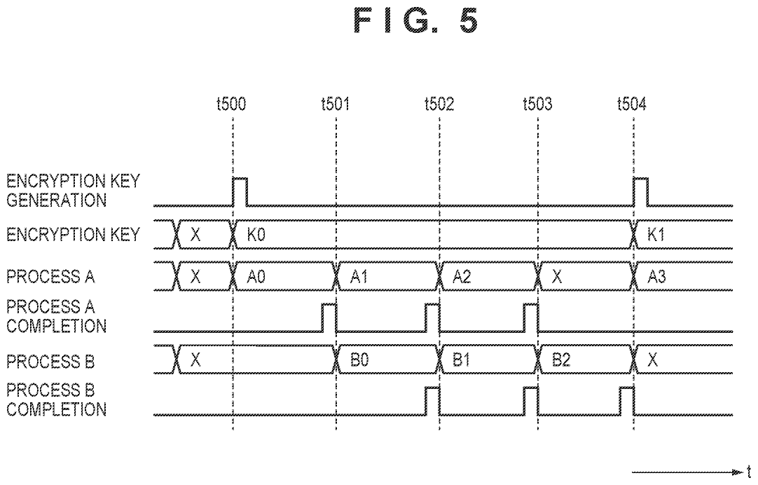

Next, referring to the timing chart shown in FIG. 5, the encryption key generation operation when the digital camera 100 is operating will be described. In FIG. 5, the encryption operation is shown when the signal processing circuit 105 executes process A and process B, both of which refer to the secret area. Here, it is assumed that the data obtained in the process A is secret data and the data obtained in the process B is not secret data. In addition, it is also assumed that the process B uses the data obtained in the process A.

At time t500, the main control circuit 120 sets the key generation instruction to High level to instruct the key generation circuit 110 to generate an encryption key. In response to this, the key generation circuit 110 generates and holds the encryption key K0. Also, at time t500, the process A starts sub-process A0. The signal processing circuit 105 writes the data obtained in the sub-process A0 to the secret area of the non-volatile storage device 112 via the DMAC 106. The data obtained in the sub-process A0 is encrypted using the encryption key K0.

At time t501, the process A completes the sub-process A0 and starts sub-process A1. The signal processing circuit 105 writes the data obtained in the sub-process A1 to the secret area of the non-volatile storage device 112 via the DMAC 106. The data obtained in the sub-process A1 is encrypted using the encryption key K0. On the other hand, the process B starts sub-process B0 while reading the result of the sub-process A0 written in the secret area. The data read out is decrypted using the encryption key K0. The signal processing circuit 105 writes the data obtained in the sub-process B0 to the normal area of the non-volatile storage device 112 via DMAC 106.

At time t502, the process A completes the sub-process A1 and starts sub-process A2. The signal processing circuit 105 writes the data obtained in the sub-process A2 to the secret area of the non-volatile storage device 112 via the DMAC 106. The data obtained in the sub-process A2 is encrypted using the encryption key K0. On the other hand, the process B starts sub-process B1 while reading the result of the sub-process A1 written in the secret area. The data read out is decrypted using the encryption key K0. The signal processing circuit 105 writes the data obtained in the sub-process B1 to the normal area of the non-volatile storage device 112 via DMAC 106.

At time t503, the process A completes the sub-process A2. Accordingly, the process A is completed. On the other hand, the process B starts sub-process B2 while reading the result of the sub-process A2 written in the secret area. The data read out is decrypted using the encryption key K0. The signal processing circuit 105 writes the data obtained in sub-process B2 to the normal area of the nonvolatile storage device 112 via DMAC 106.

At time t504, the process B completes the sub-process B2. Accordingly, the process B is completed. With the completion of the process B, the data written in the secret area during the process A is no longer required. Therefore, there is no problem even if the encryption key as the decryption key is updated. In other words, there is no problem even if the data written in the secret area during the process A cannot be decrypted. However, if the encryption key is updated before the completion of the process B, the process B cannot be correctly performed since the data written in the secret area during the process A cannot be decrypted. At time t504, the main control circuit 120 sets the key generation instruction to High level to instruct the key generation circuit 110 to generate the encryption key. In response to this, the key generation circuit 110 generates and holds an encryption key K1. The encryption key is updated accordingly.

Also, at time t504, the process A starts sub-process A3. The signal processing circuit 105 writes the data obtained in the sub-process A3 to the secret area of the non-volatile storage device 112 via the DMAC 106. The data obtained in the sub-process A3 is encrypted using the encryption key K1. Thereafter, the same operations as t501 to t503 are performed using the encryption key K1 until the completion of sub-process B5. Thereafter, the signal processing circuit 105 continues to execute the processes A and B while periodically updating the encryption key until there is no more image data to be processed.

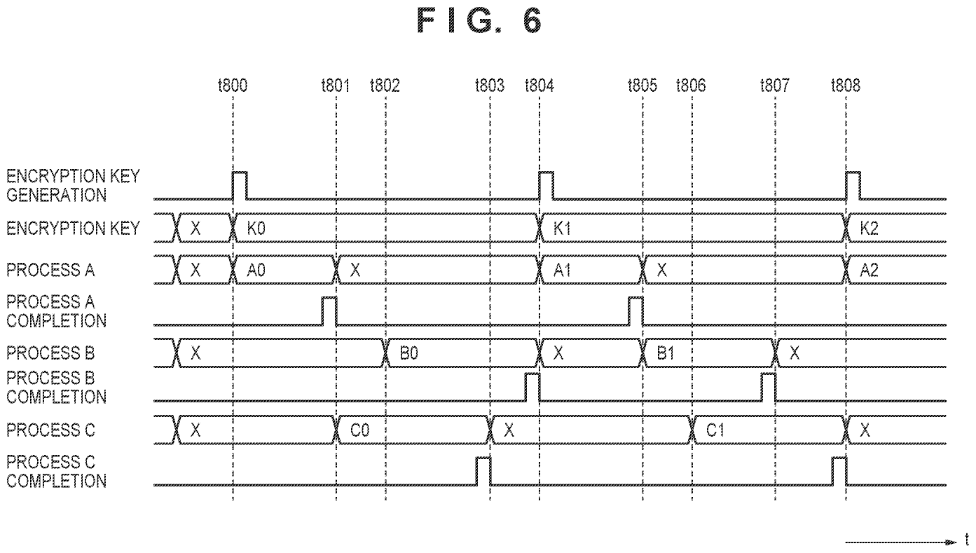

Next, referring to the timing chart shown in FIG. 6, the encryption operation when process C, in addition to the process B, refers to the data obtained in the process of process A, will be described.

At time t800, the main control circuit 120 sets the key generation instruction to High level to instruct the key generation circuit 110 to generate an encryption key. In response to this, the key generation circuit 110 generates and holds the encryption key K0. Also, at time t800, the process A starts sub-process A0. The signal processing circuit 105 writes the data obtained in the sub-process A0 to the secret area of the non-volatile storage device 112 via the DMAC 106. The data obtained in the sub-process A0 is encrypted using the encryption key K0.

At time t801, the process A completes the sub-process A0. On the other hand, the Process C starts sub-process C0 while reading the result of the sub-process A0 written in the secret area. The data read out is decrypted using the encryption key K0. The signal processing circuit 105 writes the data obtained in the sub-process C0 to the normal area of the non-volatile storage device 112 via the DMAC 106. At time t802, the process B starts sub-process B0 while reading the result of the sub-process A0 written in the secret area. The data read out is decrypted using the encryption key K0. The signal processing circuit 105 writes the data obtained in the sub-process B0 to the normal area of the non-volatile storage device 112 via the DMAC 106. Between time t802 and t803, the sub-processes C0 and B0 are executed in parallel.

At time t803, the process C completes the sub-process C0. At time t804, the Process B completes the sub-process B0. At time t804, if the main control circuit 120 detects that the sub-processes B0 and C0, which refer to the sub-process A0, are completed, the main control circuit 120 causes the encryption key to be updated. In other words, the main control circuit 120 sets the key generation instruction to High level to instruct the key generation circuit 110 to generate the encryption key. In response to this, the key generation circuit 110 generates and holds the encryption key K1.

Also, at time t804, process A starts sub-process A1. The signal processing circuit 105 writes the data obtained in the sub-process A1 to the secret area of the non-volatile storage device 112 via the DMAC 106. The data obtained in the sub-process A1 is encrypted using the encryption key K1.

At time t805, the process A completes the sub-process A1. On the other hand, the process C starts sub-process C1 while reading the result of the sub-process A1 written in the secret area. The data read out is decrypted using the encryption key K1. The signal processing circuit 105 writes the data obtained in the sub-process C1 to the normal area of the non-volatile storage device 112 via DMAC 106. At time t806, the process B starts sub-process B1 while reading the result of the sub-process A1 written in the secret area. The data read out is decrypted using the encryption key K1. The signal processing circuit 105 writes the data obtained in the sub-process B1 to the normal area of the non-volatile storage device 112 via the DMAC 106. Between time t806 and t807, the sub-processes C1 and B1 are executed in parallel.

At time t807, the process C completes the sub-process C1. At time t808, the process B completes the sub-process B1. At time t808, if the main control circuit 120 detects that the sub-processes B1 and C1, which refer to the sub-process A1, are completed, the main control circuit 120 causes the encryption key to be updated. In other words, the main control circuit 120 sets the key generation instruction to High level to instruct the key generation circuit 110 to generate the encryption key. In response to this, the key generation circuit 110 generates and holds the encryption key K2.

Also, at time t808, the process A starts sub-process A2. The signal processing circuit 105 writes the data obtained in the sub-process A2 to the secret area of the non-volatile storage device 112 via the DMAC 106. The data obtained in the sub-process A2 is encrypted using the encryption key K2. Thereafter, the processes A, B, and C execute the sub-processes in the same manner. Assuming that x=0, 1, 2 . . . , when sub-processes Bx and Cx, which refer to the result of sub-process Ax stored in the secret area, are completed, the main control circuit 120 causes the encryption key to be updated.

In this embodiment, since there is one secret area, the data obtained by the sub-process A0 and stored in the secret area will be overwritten when the data obtained by the sub-process A1 is stored and thus be unavailable. Therefore, the encryption key is updated only after detecting that all the processes that refer to the data written in the secret area have been completed. This allows the encryption key to be updated without affecting the operation of the process that refers the data encrypted using the encryption key before the update. In addition, by updating the encryption key, the confidentiality of the data written in the secret area can be further enhanced.

In the above descriptions, we have described an example where the encryption key is updated every time new data is written in the secret area. However, it is also possible to update the encryption key in a longer cycle. Also, the encryption key does not necessarily have to be updated. By holding the encryption key in the volatile storage device, even if the encryption key is not updated, the confidentiality of the data written in the secret area of the non-volatile storage device 112 is maintained in the event that the power supply is forcibly cut off.

The encryption key may be updated when a specific event occurs. Such an event may include, but is not limited to, when the buffer memory for image data is emptied during continuous shooting and when the operation mode of the digital camera 100 is changed.

According to this embodiment, when the encryption key is updated, the data encrypted using the encryption key before the update and then written in the secret area cannot be decrypted no longer. Therefore, by updating or deleting the encryption key instead of deleting the data written in the secret area, the same confidentiality effect as the deletion of data can be obtained without actually performing the delete operation of the nonvolatile storage device 112.

As explained above, according to this embodiment, the encryption key that was used to encrypt the data stored in the non-volatile storage device is held in the volatile storage device. Therefore, if the power supply is forcibly cut off, for example, by the removal of the battery in a battery-powered device, the encryption key disappears, preventing a third party from decrypting the encrypted data stored in the non-volatile storage device. As a result, the confidentiality of intermediate data and other data generated during a process in a device that uses a non-volatile storage device as its main memory can be maintained.

(Possible variation of embodiment) In the above-described embodiment, a single secret area is set to the non-volatile storage device 112 and only one encryption key is used. However, multiple secret areas may be set to the non-volatile storage device 112. In addition, the encryption key can be generated and held for each of the secret areas.

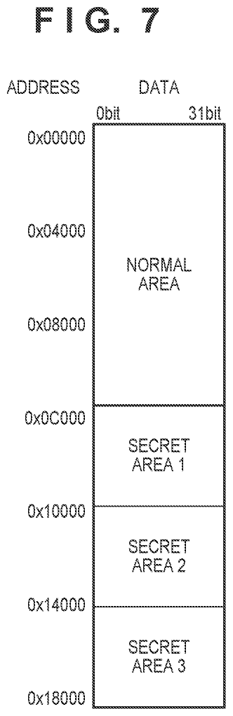

FIG. 7 shows an example of a memory map of the non-volatile storage device 112 to which three secret areas are set. In FIG. 7, the vertical axis and the horizontal axis are the same as those shown in FIG. 2. In the example, addresses from 0x00000 to 0x0FFFF are designated as a secret area 1, addresses from 0x10000 to 0x13FFF as a secret area 2, and addresses from 0x14000 to 0x17FFF as a secret area 3. In another example, even-numbered addresses may be set as the secret area 1 and odd-numbered addresses may be set as the secret area 2. In this case, the secret areas are switched every byte. Basically, there is no restriction on how to set the secret areas as long as the areas can be divided regularly by addresses.

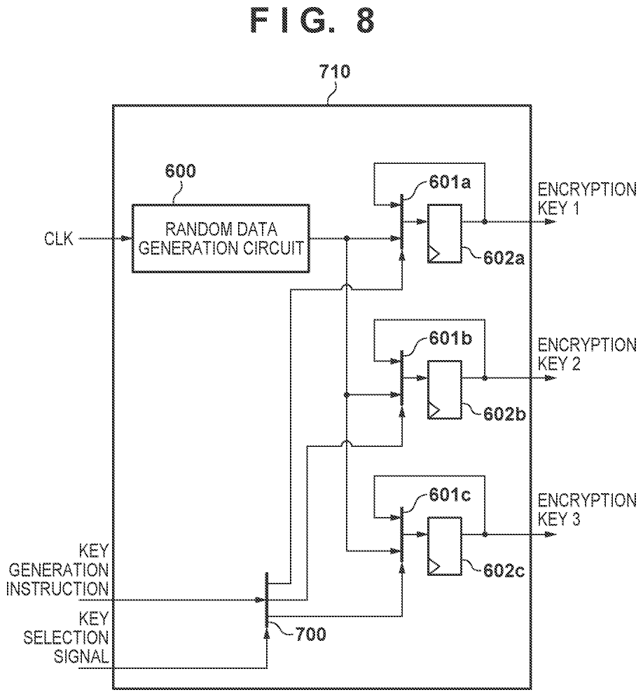

FIG. 8 shows an exemplary configuration of a key generation circuit 710 for a case where the secret areas 1 to 3 each uses a different encryption key. In FIG. 8, for components that are the same as those shown in FIG. 3, the same reference numerals as used in FIG. 3 are assigned.

In the key generation circuit 710, flip-flops 602a-602c and selectors 601a-601c are respectively provided for each secret area to hold the encryption key. In the key generation circuit 710, a key selection circuit 700 for distributing the random data output by the random data generation circuit 600 to the flip-flops 602a to 602c is also provided.

The key selection circuit 700 outputs, for example, a key generation instruction to one of the selectors 601a to 601c according to the value of the selection signal. The key selection circuit 700, for example, outputs the key generation instruction to the selector 601a if the selection signal is 0, to the selector 601b if the selection signal is 1, and to the selector 601c if the selection signal is 2. This allows the random data (encryption keys 1 to 3) generated by the random data generation circuit 600 at different timings to be held in the flip-flops 602a to 602c according to the value of the selection signal.

The encryption processing circuit 108 determines which of the secret areas 1 to 3 is accessed based on the ADR signal output by the DMAC 106. Then the encryption processing circuit 108 can acquire the encryption key corresponding to the determined secret area from the key generation circuit 710 and perform encryption or decryption.

### Other Embodiments

In the above-described embodiments, it is assumed that an encryption method uses the same information (encryption key) for both encryption and decryption of data. However, the essence of the present invention is to hold or store in the volatile storage device the information necessary for decrypting the encryption that has been applied to the data stored in the secret area of the nonvolatile storage device 112. Therefore, in a case where an encryption method using different information for encryption and decryption is used, the information used for decryption (a decryption key) of the encrypted data stored in the secret area is to be held in the volatile storage device in the key generation circuit 110. In this case, the encryption key may or may not be held in the volatile storage device in the key generation circuit 110. In a case where a decryption key is used, the key generation circuit 110 can be configured to generate the decryption key when generating (or updating) the encryption key.

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-149178, filed on Sep. 4, 2020, which is hereby incorporated by reference herein in its entirety.

What is claimed is:

1. An information processing apparatus comprising:
an encryption circuit that encrypts data;
a writing circuit that stores the data encrypted by the encryption circuit in a non-volatile storage device; and
a volatile storage device that stores information used to decrypt the data encrypted by the encryption circuit.

2. The information processing apparatus according to claim 1, further comprising a generation circuit that generates the information and stores the information in the volatile storage device in a case where the information does not exist in the volatile storage device.

3. The information processing apparatus according to claim 2, wherein the generation circuit generates and stores the information in the volatile storage device at least at one of: at the time of starting up of the information processing apparatus and at the time that an operation mode of the information processing apparatus is changed.

4. The information processing apparatus according to claim 2, wherein the information generated by the generation circuit is different for each generation.

5. The information processing apparatus according to claim 1,
wherein the non-volatile storage device includes a plurality of areas, and
wherein the encryption circuit encrypts data to be stored in an area being set as an area for storing encrypted data among the plurality of areas.

6. The information processing apparatus according to claim 5, wherein in a case where there are two or more areas are set as the area for storing the encrypted data, the volatile storage device stores the information for each of the two or more areas.

7. The information processing apparatus according to claim 1, wherein, the information processing apparatus deletes or updates the information used to decrypt the data encrypted and stored in the non-volatile storage device, instead of deleting the encrypted data from the non-volatile storage device.

8. The information processing apparatus according to claim 1,
wherein the encryption circuit decrypts the encrypted data read from the non-volatile storage device using the information stored in the volatile storage device, and
wherein the information stored in the volatile storage device is protected so that the information can be referenced or read only by the encryption circuit.

9. The information processing apparatus according to claim 1, wherein the information stored in the volatile storage device is information that the encryption circuit also uses to encrypt data.

10. The information processing apparatus according to claim 1, wherein the data to be encrypted by the encryption circuit is data temporarily stored in the non-volatile storage device.

11. The information processing apparatus according to claim 1, wherein the non-volatile storage device is used as a main memory of the information processing apparatus.

12. A control method of an information processing apparatus, comprising:
encrypting data;
writing the encrypted data to a non-volatile storage device; and
writing information used for decrypting the encrypted data to a volatile storage device.

13. A non-transitory machine-readable medium storing a program for causing a computer to execute a control method of an information processing apparatus, the control method comprising:
encrypting data;
writing the encrypted data to a non-volatile storage device; and
writing information used for decrypting the encrypted data to a volatile storage device.
